(19) United States
(12) Patent Application Publication
(10) Pub. No.: US 2006/0245495 A1
(43) Pub. Date: Nov. 2, 2006

(54) Video coding method and apparatus supporting fast fine granular scalability

(75) Inventors: Woo-jin Han, Suwon-si (KR); Kyo-hyuk Lee, Seoul (KR); Sang-chang Cha, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/410,955

(22) Filed: Apr. 26, 2006

Related U.S. Application Data
(60) Provisional application No. 60/675,921, filed on Apr. 29, 2005.

(30) Foreign Application Priority Data
Jun. 17, 2005 (KR) 10-2005-0052428

(51) Int. Cl. H04N 11/04

(52) U.S. Cl. 375/240.13

(57) ABSTRACT

A method for reducing the amount of computations required for multilayer-based progressive fine granular scalability (PFGS) algorithm and a video coding method and apparatus employing the same method are provided. The video coding method supporting fine granular scalability (FGS) includes obtaining a predicted image for a current frame using a motion vector estimated at predetermined accuracy, quantizing a residual between the current frame and the predicted image, inversely quantizing the quantized residual, and generating a reconstructed image for the current frame, performing motion compensation on an FGS layer reference frame and a base layer reference frame using the estimated motion vector, calculating a residual between the motion-compensated FGS layer reference frame and the motion-compensated base layer reference frame, subtracting the reconstructed image for the current frame and the calculated residual from the current frame, and encoding the result of subtraction.

### CROSS-REFERENCE TO RELATED APPLICATIONS

This application claims priority from Korean Patent Application No. 10-2005-0052428 filed on Jun. 17, 2005 in the Korean Intellectual Property Office, and U.S. Provisional Patent Application No. 60/675,921 filed on Apr. 29, 2005 in the United States Patent and Trademark Office, the disclosures of which are incorporated herein by reference in their entirety.

### BACKGROUND OF THE INVENTION

1. Field of the Invention

Methods and apparatuses consistent with the present invention relate to video coding, and more particularly, to video coding which reduces the amount of computations required for a multilayer-based Progressive Fine Granular Scalability (PFGS) algorithm.

2. Description of the Related Art

With the development of information communication technology, including the Internet, there have been increasing multimedia services containing various kinds of information such as text, video, audio and so on. Multimedia data requires a large capacity of storage media and a wide bandwidth for transmission since the amount of multimedia data is usually large. Accordingly, a compression coding method is a requisite for transmitting multimedia data including text, video, and audio.

A basic principle of data compression is removing data redundancy. Data can be compressed by removing spatial redundancy in which the same color or object is repeated in an image, temporal redundancy in which there is little change between neighboring frames in a moving image or the same sound is repeated in audio, or mental visual redundancy taking into account human eyesight and limited perception of high frequency. In general video coding, temporal redundancy is removed by temporal filtering based on motion compensation, and spatial redundancy is removed by spatial transformation.

To transmit multimedia generated after removing data redundancy, transmission media are required. Different types of transmission media for multimedia have different performance. Currently used transmission media have various transmission rates. For example, an ultrahigh-speed communication network can transmit data of several tens of megabits per second while a mobile communication network has a transmission rate of 384 kilobits per second. To support transmission media having various speeds or to transmit multimedia, data coding methods having scalability may be suitable to a multimedia environment.

Scalability indicates the ability to partially decode a single compressed bitstream. Scalability includes spatial scalability indicating a video resolution, Signal-to-Noise Ratio (SNR) scalability indicating a video quality level, and temporal scalability indicating a frame rate.

Standardization work for implementation of multi-layer scalability based on H.264 Scalable Extension (hereinafter, to be referred to be as “H.264 SE”) is in progress at present by a joint video team (JVT) of MPEG (Motion Picture Experts Group) and ITU (International Telecommunication Union). To support SNR scalability, existing Fine Granular Scalability (FGS) techniques are being adopted by the JVT.

FIG. 1 is a diagram for explaining a conventional Fine Granular Scalability (FGS) technique. A FGS-based codec performs coding by dividing a video bitstream into a base layer and an FGS layer. Throughout this specification, a prime (′) notion is used to denote a reconstructed image obtained after quantization/inverse quantization. More specifically, a block PB predicted from a block MB′ in a reconstructed left base layer frame 11 and a block NB′ in a reconstructed right base layer frame 12 using a motion vector is subtracted from a block O in an original current frame 12 to obtain a difference block RB. Thus, the difference block RB can be defined by the Equation (1):
R_{B}=O−P_{B}=O−(M_{B}′+N_{B}′)/2 (1)

The difference block R_{B} is quantized by a base layer quantization step QP_{B} (RB^{Q}) and then inversely quantized to obtain a reconstructed difference block R_{B}′. A residual between the unquantized difference block R_{B} and the reconstructed difference block R_{B}′ is calculated and a block Δ corresponding to the residual is quantized with a quantization step size QP_{F} smaller than the base layer quantization step size QP_{B} (a compression rate decreases as a quantization step size decreases). The quantized Δ is denoted by Δ^{Q}. The quantized difference block R_{B}^{Q} in the base layer and the quantized block Δ^{Q} in the FGS layer are eventually transmitted to a decoder.

FIG. 2 is a diagram for explaining a conventional progressive fine granular scalability (PFGS) technique. A conventional FGS technique uses a reconstructed quantized base layer residual R_{B}′ to reduce the amount of data in an FGS layer. Referring to FIG. 2, a PFGS technique uses the fact that the quality of left and right reference frames in an FGS layer are also improved by a FGS technique. That is, the PFGS technique involves calculating a new difference block R_{F} using newly updated left and right reference frames 21 and 23 and quantizing a residual between the new difference block R_{F} and a quantized base layer block R_{B}′, thereby improving coding performance. The new difference block RF is defined by the Equation (2):
R_{F}=O−P_{F}=O−(M_{F}′+N_{F}′)/2 (2)
where M_{F}′ and N_{F}′ respectively denote regions in the reconstructed left and right reference frames 21 and 23 in an FGS layer corresponding to appropriate motion vectors.

A PFGS technique has an advantage over a FGS technique that the amount of data in an FGS layer can be reduced due to high quality of left and right reference frames. Because the FGS layer also requires separate motion compensation, the amount of computations increases. That is, while the PFGS has improved performance over the conventional FGS, it requires a large amount of computations because motion compensation is performed for each FGS layer to generate a predicted signal and a residual signal between the predicted signal and the original signal. Recently developed video codecs interpolate an image signal at ½ or ¼ pixel accuracy for motion compensation. When motion compensation is performed on ¼ pixel accuracy, an image with size corresponding to quadruple the resolution of an original image should be generated.

H.264 standard SE technique uses a six-tap filter as a ½ pixel interpolation filter that involves a considerable computational complexity, requiring quite a quantity of computations for motion compensation. This complicates encoding and decoding processes, thus requiring higher system resources. In particular, this drawback may be most problematic in a field requiring real-time encoding and decoding, such as real-time broadcasting or video conferencing.

### SUMMARY OF THE INVENTION

The present invention provides a method and apparatus for reducing an amount of computations required for motion compensation while maintaining the performance of a progressive fine granular scalability (PFGS) algorithm.

According to an aspect of the present invention, there is provided a video encoding method supporting FGS, the video encoding method including obtaining a predicted image for a current frame using a motion vector estimated at predetermined accuracy, quantizing a residual between the current frame and the predicted image, inversely quantizing the quantized residual and generating a reconstructed image for the current frame, performing motion compensation on an FGS layer reference frame and a base layer reference frame using the estimated motion vector, calculating a residual between the motion-compensated FGS layer reference frame and the motion-compensated base layer reference frame, subtracting the reconstructed image for the current frame and the calculated residuals from the current frame, and encoding the result of subtraction.

According to another aspect of the present invention, there is provided a video encoding method supporting FGS, the video encoding method including obtaining a predicted image for a current frame using a motion vector estimated at predetermined accuracy, quantizing a residual between the current frame and the predicted image, inversely quantizing the quantized residual, and generating a reconstructed image for the current frame, performing motion compensation on an FGS layer reference frame and a base layer reference frame using the estimated motion vector and generating a predicted frame for the FGS layer and a predicted frame for the base layer, respectively, calculating a residual between the predicted frame for the FGS layer and the predicted frame for the base layer, subtracting the reconstructed image and the residual from the current frame, and encoding the result of subtraction.

According to still another aspect of the present invention, there is provided a video encoding method supporting FGS, the video encoding method including obtaining a predicted image for a current frame using a motion vector estimated at predetermined accuracy, quantizing a residual between the current frame and the predicted image, inversely quantizing the quantized residual, and generating a reconstructed image for the current frame, calculating a residual between an FGS layer reference frame and a base layer reference frame, performing motion compensation on the residual using the estimated motion vector, subtracting the reconstructed image and the motion-compensated result from the current frame, and encoding the result of subtraction.

According to yet another aspect of the present invention, there is provided a video encoding method supporting fine granular scalability (FGS), the video encoding method including obtaining a predicted image for a current frame using a motion vector estimated at predetermined accuracy, performing motion compensation on an FGS layer reference frame and a base layer reference frame using a motion vector with lower accuracy than that of the estimated motion vector, calculating a residual between the motion-compensated FGS layer and base layer reference frame, subtracting the predicted image and the residual from the current frame, and encoding the result of subtraction.

According to still yet another aspect of the present invention, there is provided a video encoding method supporting FGS, the video encoding method including obtaining a predicted image for a current frame using a motion vector estimated at predetermined accuracy, performing motion compensation on an FGS layer reference frame and a base layer reference frame using a motion vector with lower accuracy than that of the estimated motion vector and generating a predicted frame for the FGS layer and a predicted frame for the base layer, respectively, calculating a residual between the predicted frame for the FGS layer and the predicted frame for the base layer, subtracting the predicted image and the calculated residual from the current frame, and encoding the result of subtraction.

According to yet another aspect of the present invention, there is provided a video encoding method supporting FGS, the video encoding method including obtaining a predicted image for a current frame using a motion vector estimated at predetermined accuracy, calculating a residual between an FGS layer reference frame and a base layer reference frame, performing motion compensation on the residual using a motion vector with lower accuracy than that of the estimated motion vector, subtracting the reconstructed image and the motion-compensated result from the current frame, and encoding the result of subtraction.

According to another aspect of the present invention, there is provided a video decoding method supporting FGS, the video decoding method including extracting base layer texture data and FGS layer texture data and motion vectors from an input bitstream, reconstructing a base layer frame from the base layer texture data, performing motion compensation on an FGS layer reference frame and a base layer reference frame using the motion vectors, calculating a residual between the motion-compensated FGS layer reference frame and the motion-compensated base layer reference frame, and adding together the base layer frame, the FGS layer texture data, and the residual.

According to a further aspect of the present invention, there is provided an FGS-based video encoder including an element obtaining a predicted image for a current frame using a motion vector estimated at predetermined accuracy, an element quantizing a residual between the current frame and the predicted image, inversely quantizing the quantized residual, and generating a reconstructed image for the current frame, an element performing motion compensation on an FGS layer reference frame and a base layer reference frame using the estimated motion vector, an element calculating a residual between the motion-compensated FGS layer and base layer reference frame, an element subtracting the reconstructed image and the residual from the current frame, and an element encoding the result of subtraction.

According to yet a further aspect of the present invention, there is provided an FGS-based video decoder, the video encoder including an element extracting base layer texture data, FGS layer texture data and motion vectors from an input bitstream, an element reconstructing a base layer frame from the base layer texture data, an element performing motion compensation on an FGS layer reference frame and a base layer reference frame using the motion vector and generating a predicted FGS layer frame and a predicted base layer frame, an element calculating a residual between the predicted FGS layer frame and the predicted base layer frame, and an element adding together the texture data, the reconstructed base layer frame, and the residual.

### BRIEF DESCRIPTION OF THE DRAWINGS

The above and other aspects of the present invention will become more apparent by describing in detail exemplary embodiments thereof with reference to the attached drawings in which:

FIG. 1 is a diagram for explaining a conventional FGS technique;

FIG. 2 is a diagram for explaining conventional progressive PFGS technique;

FIG. 3 is a diagram for illustrating fast progressive fine granular scalability (PFGS) according to an exemplary embodiment of the present invention;

FIG. 4 is a block diagram of a video encoder according to an exemplary embodiment of the present invention;

FIG. 5 is a block diagram of a video encoder according to another exemplary embodiment of the present invention;

FIGS. 6 and 7 are block diagrams of video encoders according a further exemplary embodiment of the present invention;

FIG. 8 is a block diagram of a video decoder according to an exemplary embodiment of the present invention;

FIG. 9 is a block diagram of a video decoder according to another exemplary embodiment of the present invention;

FIGS. 10 and 11 are block diagrams of video decoders according to a further exemplary embodiment of the present invention; and

FIG. 12 is a block diagram of a system for performing an encoding or decoding process according to an exemplary embodiment of the present invention.

### DETAILED DESCRIPTION OF EXEMPLARY EMBODIMENTS THE INVENTION

The present invention will now be described more fully with reference to the accompanying drawings, in which exemplary embodiments of the invention are shown.

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

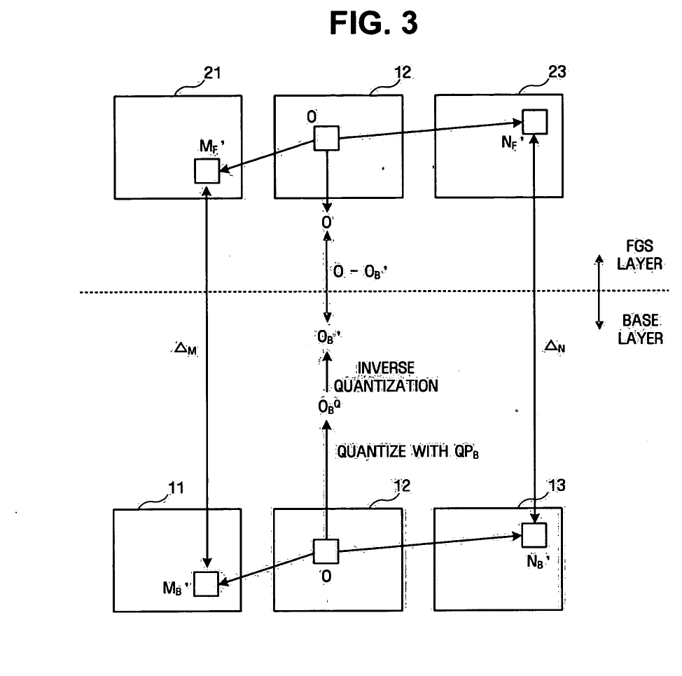

FIG. 3 is a diagram for illustrating PFGS according to a first exemplary embodiment of the present invention.

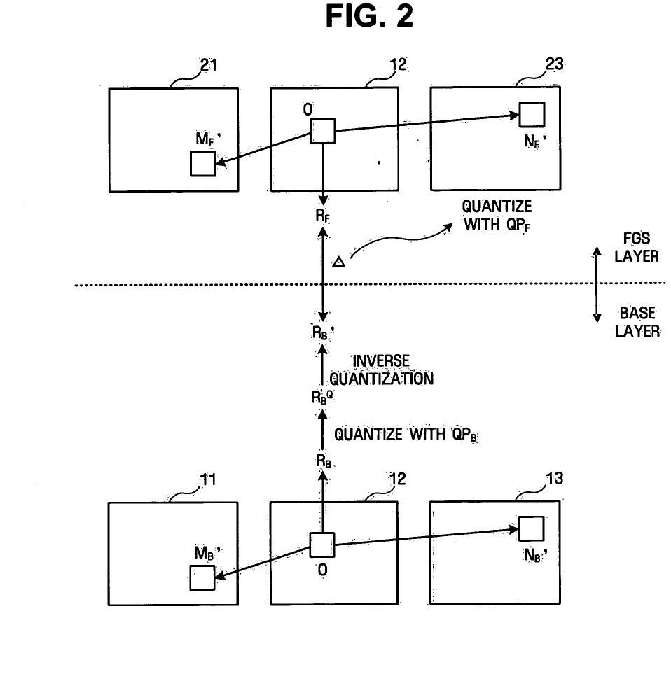

Referring to FIG. 3, like in FIG. 2, Δ in an FGS layer will be quantized according to a PFGS algorithm and defined simply by the Equation (3):
Δ=R_{F}−R_{B}′ (3)

R_{F} is defined by the above Equation (2) and R_{B}′ is defined by the Equation (4):
R_{B}′=O′−P_{B}=O′−(M_{B}′+N_{B}′)/2 (4)
where O′ is an image reconstructed by quantizing an original image O with a base layer quantization step size QP_{B} and then inversely quantizing the quantized image.

Substituting the Equations (2) and (4) into the Equation (3) gives the Equation (5):
Δ=O−(M_{F}′+N_{F}′)/2−[O′−(M_{B}′+N_{B}′)/2] (5)

Referring to FIG. 3, Δ_{M} and Δ_{N} denote a residual between left reference frames M_{F}′ and M_{B}′ in the base layer and the FGS layer and a residual between right reference frames N_{F}′ and N_{B}′ in the base layer and the FGS layer, respectively, and are defined by the Equation (6):
Δ_{M}=M_{F}′−M_{B}′
Δ_{N}=N_{F}′−N_{B}′ (6)

By substituting the Equation (6) into the Equation (5), Δ can be defined by the Equation (7):
Δ=O−O′−(Δ_{M}+Δ_{N})/2 (7)

As shown in the Equation (7), an encoder can obtain Δ by subtracting the reconstructed base layer image O′ obtained by quantizing the original image O with the base layer quantization step size QP_{B} and then inversely quantizing the quantized image and an average of the residuals between each of the base reference frame and the FGS layer reference frame and the original image O, that is, (Δ_{M}+Δ_{N})/2. A decoder reconstructs the original image O by adding together the reconstructed base layer image O′, Δ, and the average of the residuals between the base layer reference frame and the FGS layer reference frame.

In a conventional PFGS algorithm, motion compensation is performed using a motion vector with one pixel or sub-pixel (½ pixel or ¼ pixel) accuracy obtained by motion estimation. Recently, in order to increase compression efficiency, motion estimation and compensation are typically performed according to various pixel accuracies such as half pixel accuracy, or quarter pixel accuracy. In conventional PFGS, a predicted image generated by motion compensation with, e.g., ¼ pixel accuracy, is packed into integer pixels. Then, quantization is performed on a residual between an original image and the predicted image. In this case, the packing is a restoration process of a 4× interpolated reference image into the original size image by performing motion estimation with ¼ pixel accuracy. For example, one of every four pixels may be selected during the packing process.

However, the data Δ in the FGS layer to be quantized for fast PFGS according to the present invention, as defined by the Equation (7), which affect little compression efficiency, needs not be subjected to motion estimation with high pixel accuracy. Motion estimation and compensation are applied to only the third term (Δ_{M}+Δ_{M})/2 in the right-hand side of the Equation (7). However, because the third term is represented as interlayer residuals between reference frames, it is not highly effective to perform motion estimation and compensation with high pixel accuracy. That is, because the resulting residual image between an image in a base layer motion-compensated with predetermined pixel accuracy and an image in an enhancement layer motion-compensated with the pixel accuracy is insensitive to pixel accuracy, the fast PFGS allows lower pixel accuracy motion estimation and compensation than the conventional PFGS.

According to a second exemplary embodiment, Δ in the Equation (5) in the first exemplary embodiment can also be represented as a residual between predicted signals P_{F} and P_{B} as shown in the Equation (8). P_{F} and P_{B} are equal to (M_{F}′+N_{F}′)/2 and (M_{B}′+N_{B}′)/2, respectively.
Δ=O−O′−(P_{F}−P_{B}) (8)

The first and second exemplary embodiments are distinguished from each other as follows. In the first exemplary embodiment, residuals Δ_{M} and Δ_{N} between FGS layer reference images and base layer reference images are first calculated and then divided by 2. In the second exemplary embodiment, the residual P_{F}−P_{B} between the predicted FGS layer image P_{F} and the predicted base layer image P_{B} is calculated after calculating the predicted images P_{F} and P_{B} in the two layers. That is to say, although fast PFGS algorithms according to the first and second exemplary embodiments are implemented in different ways, the same calculation result (Δ) can be obtained.

In both the first and second exemplary embodiments, motion compensation is first performed and a residual between images is then calculated. In a third exemplary embodiment of the present invention, a residual between reference images in different layers may first be calculated, followed by performing motion compensation. In this way, according to the third exemplary embodiment of the present invention, because motion compensation is performed on a residual, boundary padding little affects the resulting image. Thus, a boundary padding process may be skipped. The boundary padding is the process of duplicating pixels at boundaries in the vicinity of the pixels considering that block matching at a frame boundary is restricted during motion estimation.

In the third exemplary embodiment of the present invention, a residual Δ can be defined by the Equation (9):
Δ=O−O′−[(mc(M_{F}′−M_{B}′)+mc(N_{F}′−N_{B}′))/2 (9)
where mc(.) denotes a function for performing motion compensation.

While a conventional PFGS is used to perform direct prediction (motion estimation and compensation) for calculating R_{F} or R_{B} defined by the Equation (3), the fast PFGS algorithms according to the first through third exemplary embodiments of the present invention are used to calculate a residual between predicted images or predict a residual between reference images. Thus, the fast PFGS performance of the present invention is only slightly affected by or insensitive to interpolation used in order to increase the pixel accuracy of motion vector.

Thus, quarter or half pixel interpolation may be skipped. Furthermore, a bi-linear filter requiring a smaller amount of computations may be use instead of a half-pixel interpolation filter used in the H.264 standard requiring a large amount of computations. For example, a bi-linear filter may be applied to the third terms in the right-hand sides of the Equations (7) through (9). This may reduce degradation in performance compared to when a bi-linear filter is directly applied to a predicted signal for obtaining R_{F} and R_{B} as in a conventional PFGS algorithm.

The principle of the first through third exemplary embodiments of the present invention is based on the Equation (3). In other words, implementation of these exemplary embodiments starts on the assumption that a residual between an FGS layer residual R_{F} and a base layer residual R_{B} is to be coded. However, when the residual obtained from the FGS layer is very small, i.e., when a temporal correlation is very close, the above fast PFGS algorithms according to the first through third exemplary embodiments may rather degrade coding performance. In this case, coding only the residual obtained from the FGS layer, i.e., R_{F} in the Equation (3), may offer better coding performance. That is, according to a fourth exemplary embodiment of the present invention, the Equations (7) through (9) may be modified into the Equations (10) through (12), respectively:
Δ=O−P_{B}−(Δ_{M}+Δ_{N})/2 (10)
Δ=O−P_{B}−(P_{F}−P_{B}) (11)
Δ=O−P_{B}−[(mc(M_{F}′−M_{B}′)+mc(N_{F}′−N_{B}′))/2 (12)

In the Equations (10) through (12), the reconstructed base layer image O′ is replaced with a predicted image P_{B} for a base layer image. Of course, interpolation may not be applied to the third terms in the right-hand side of the Equations (10) through (12), or a bi-linear filter requiring a smaller amount of computations may be used for interpolation.

The predicted image P_{B} occurring twice in the Equation (11) is not necessarily the same one. An estimated motion vector may be used during motion compensation to generate the predicted image P_{B} in a second term. On the other hand, a motion vector with lower accuracy than the estimated motion vector or a filter requiring a small amount of computations (e.g., bi-linear filter) may be used during motion compensation to generate P_{B} and P_{F} in a third term.

A PFGS algorithm in which a current frame is reconstructed using both reconstructed left and right reference frames suffers from a drift error caused when the degradation of image quality in both the left and right reference frames is cumulatively reflected in a current frame. The drift error can be reduced by a leaky prediction method using a predicted image created by a weighted sum of a predicted image obtained from both the reference frames and a predicted image obtained from a base layer.

According to a leaky prediction method used in conventional PFGS, a value being coded in an FGS layer is expressed by the Equation (13):
Δ=O−[αPF+(1−α)P_{B]} (13)

The Equation (13) can be converted into the Equation (14) according to a fifth exemplary embodiment of the present invention:
Δ=O−P_{B}−α(P_{F}−P_{B}) (14)

To obtain the Equation (14), a weighting factor α can only be applied to the residual (P_{F}−P_{B}) between predicted images in the Equation (11). Thus, the present invention can also be applied to a leaky prediction method. That is, interpolation may be skipped or interpolation may be applied to the residual (P_{F}−P_{B}) using a bi-linear filter requiring a smaller amount of computations. In the latter case, the result of interpolation is multiplied by the weighting factor α.

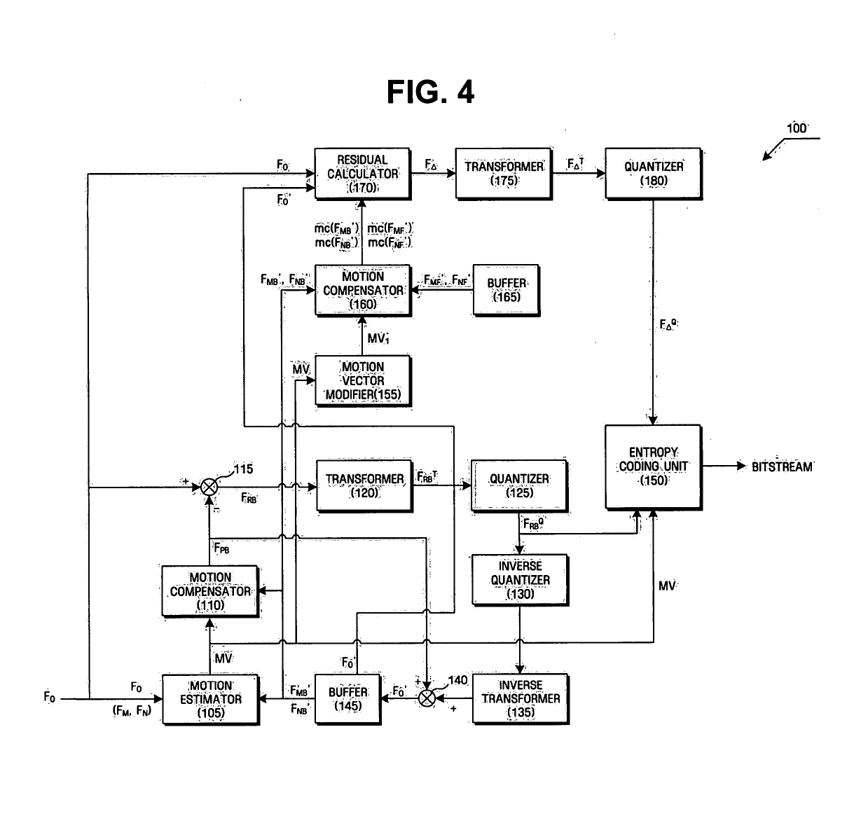

FIG. 4 is a block diagram of a video encoder 100 according to a first exemplary embodiment of the present invention.

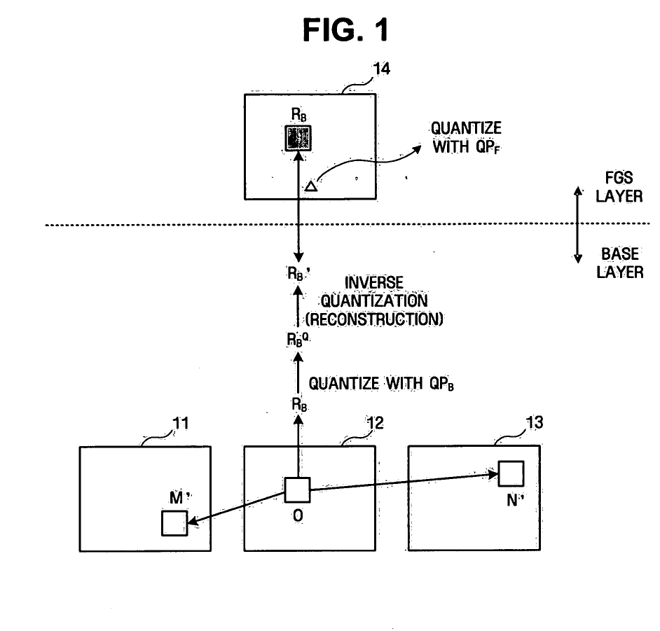

Although the invention is described with regard to each block as a basic unit of motion estimation with reference to FIGS. 1 through 3, fast PFGS that follows will be described with regard to each frame containing the block. For consistency of expression, an identifier of the block is indicated by a subscript for an “F” indicating a frame. For example, a frame containing a block labeled R_{B} is denoted by F_{RB}. Of course, a prime (′) notion is used to denote reconstructed data obtained after quantization/inverse quantization.

A current frame F_{O} is fed into a motion estimator 105, a subtractor 115, and a residual calculator 170.

The motion estimator 105 performs motion estimation on the current frame F_{O} using neighboring frames to obtain motion vectors MVs. The neighboring frames that are referred to during motion estimation are hereinafter called “reference frames”. A block matching algorithm (BMA) is commonly used to estimate the motion of a given block. In the BMA, a given block is moved within a search area in a reference frame at pixel or sub-pixel accuracy and a displacement with a minimum error is determined as a motion vector. While a fixed-size motion block is used for motion estimation, the motion estimation may make use of a hierarchical variable size block matching (HVSBM) technique.

When motion estimation is performed at sub-pixel accuracy, reference frames need to be upsampled or interpolated to predetermined resolution. For example, when the motion estimation is performed at ½ and ¼ pixel accuracies, reference frames must be updated or interpolated by a factor of two and four, respectively.

When the encoder 100 has an open-loop codec structure, original neighboring frames F_{M} and F_{N} are used as the reference frames. When the encoder 100 has a closed-loop codec structure, reconstructed neighboring frames F_{MB}′ and F_{NB}′ in a base layer are used as the reference frames. While it is herein assumed that the encoder 100 has a closed-loop codec structure, the encoder 100 may have an open-loop codec structure.

The motion vectors MVs calculated by the motion estimator 105 are provided to a motion compensator 110. The motion compensator 110 performs motion compensation on the reference frames F_{MB}′ and F_{NB}′ using the motion vectors MVs and generates a predicted frame F_{PB} for the current frame. When bidirectional prediction is used, the predicted image can be calculated as an average of motion-compensated reference frames. When unidirectional prediction is used, the predicted image may be the same as the motion-compensated reference frame. While it is assumed hereinafter that motion estimation and compensation use bidirectional reference frames, it will be apparent to those skilled in the art that the present invention may use a unidirectional reference frame.

The subtractor 115 calculates a residual F_{RB} between the predicted image and the current image for transmission to a transformer 120.

The transformer 120 performs spatial transform on the residual F_{RB} to create a transform coefficient F_{RB}^{T}. The spatial transform method may include a discrete cosine transform (DCT), or wavelet transform. Specifically, DCT coefficients may be created in a case where DCT is employed, and wavelet coefficients may be created in a case where wavelet transform is employed.

A quantizer 125 applies quantization to the transform coefficient F_{RB}^{T}. Quantization means the process of expressing the transform coefficients formed in arbitrary real values by discrete values, and matching the discrete values with indices according to the predetermined quantization table. For example, the quantizer 125 may divide the real-valued transform coefficient by a predetermined quantization step size and round the resulting value to the nearest integer. In general, the quantization step size of a base layer is greater than that of an FGS layer.

The quantization result, that is, a quantization coefficient F_{RB}^{Q} obtained by the quantizer 125 is provided to an entropy coding unit 150 and an inverse quantizer 130.

The inverse quantizer 130 inversely quantizes the quantization coefficient F_{RB}^{Q}. Inverse quantization means an inverse quantization process to restore values matched to indices generated during quantization using the same quantization step used in the quantization.

An inverse transformer 135 receives the inverse quantization result and performs an inverse transform on the received. Inverse spatial transform may be, for example, inverse DCT or inverse wavelet transform, performed in a reverse order to that of transformation performed by the transformer 120. An adder 140 adds the inversely transformed result to the predicted image FP_{B} obtained from the motion compensator 110 in order to generate a reconstructed image F_{O}′ for the current frame.

A buffer 145 stores the addition result received from the adder 140. The buffer 145 stores the reconstructed image F_{O}′ for the current frame as well as the previously reconstructed base layer reference frames F_{MB}′ and F_{NB}′.

A motion vector modifier 155 changes the accuracy of the received motion vector MV. For example, the motion vector MV with ¼ pixel accuracy may have a value of 0, 0.25, 0.5, or 0.75. As described above, according to the exemplary embodiments of the present invention, there is little difference in coding performance when motion compensation in the FGS layer is performed a motion vector MV with lower pixel accuracy than in the base layer. Thus, the motion vector modifier 155 changes the motion vector MV with ¼ pixel accuracy into motion vector MV₁ with pixel accuracy lower than the ¼ pixel accuracy, such as ½ pixel or 1 pixel. Such a changing procedure can be performed by simply truncating or rounding off the decimal part of the pixel accuracy from the original motion vector.

A buffer 165 temporarily stores FGS layer reference frames F_{MF}′, F_{NF}′. Although not illustrated, reconstructed FGS layer frames F_{MF}′ and F_{NF}′ or an original frame adjacent to the current frame may be used as the FGS layer reference frames.

The motion compensator 160 uses the modified motion vector MV₁ to perform motion compensation on the reconstructed base layer reference frames F_{MB}′ and F_{NB}′ received from the buffer 145 and the reconstructed FGS layer reference frames F_{MF}′ and F_{NF}′ received from the buffer 165 and provides the motion-compensated frames mc(F_{MB}′), mc(F_{NB}′), mc(F_{MF}′), and mc(F_{NF}′) to the residual calculator 170. F_{MF}′ and F_{NF}′ denote forward and backward reference frames in the FGS layer, respectively. F_{MB}′ and F_{NB}′ denote forward and backward reference frames in the base layer, respectively.

When interpolation is required for motion compensation, the motion compensator 160 may use a different type of interpolation filter than that used for the motion estimator 105 or motion compensator 110. When the motion vector MV₁ with ½ pixel accuracy, for example, is used, a bi-linear filter requiring a small amount of computations may be used for interpolation instead of a six-tap filter used in the H.264 standard. Because a residual between a motion-compensated base layer frame and a motion-compensated FGS layer is calculated after interpolation, the interpolation process little affects the compression efficiency.

The residual calculator 170 calculates a residual between the motion-compensated FGS layer reference frame mc(F_{MF}′), mc(F_{NF}′) and the motion-compensated base layer reference frame mc(F_{MB}′), mc(F_{NB}′). That is, the residual calculator 170 calculates Δ_{M}=mc(F_{MF}′)−mc(F_{MB}′) and Δ_{N}=mc(F_{NF}′)−mc(F_{NB}′). Of course, when a unidirectional reference frame is used, only one residual may be calculated.

Then, the residual calculator 170 calculates an average of the residuals Δ_{M} and Δ_{N} and subtracts the reconstructed image F_{O}′ and the average of the residuals Δ_{M} and Δ_{N} from the current frame F_{O}. When a unidirectional reference frame is used, the process of calculating the average is not required.

The subtraction result F_{Δ} obtained by the residual calculator 170 is subjected to spatial transform by a transformer 175 and then quantized by a quantizer 180. The quantized result F_{Δ}^{Q} is transmitted to the entropy coding unit 150. The quantization step size used in the quantizer 180 is typically less than that used in the quantizer 125.

The entropy coding unit 150 losslessly encodes the motion vector MV estimated by the motion estimator 105, the quantization coefficient F_{RB}^{Q} received from the quantizer 125, the quantized result F_{Δ}^{Q} received from the quantizer 180 into a bitstream. There are a variety of lossless coding methods including arithmetic coding, variable length coding, and the like.

Alternatively, although not shown in the drawing, a video encoder according to a second exemplary embodiment of the present invention may have the same configuration and operation as the video encoder 100 shown in FIG. 4, except a residual calculator.

That is, the residual calculator according to the second exemplary embodiment of the present invention generates a predicted frame for each layer before calculating a residual between frames in different layers. In other words, the residual calculator generates the predicted FGS layer frame and a predicted base layer frame using a motion-compensated FGS layer reference frame and a motion-compensated base layer reference frame. The predicted frame can be calculated by simply averaging the two motion-compensated reference frames. Of course, when unidirectional prediction is used, the motion-compensated frame may be the predicted frame itself.

The residual calculator then calculates a residual between the predicted frames, and subtracts a reconstructed image and the calculated residual from a current frame.

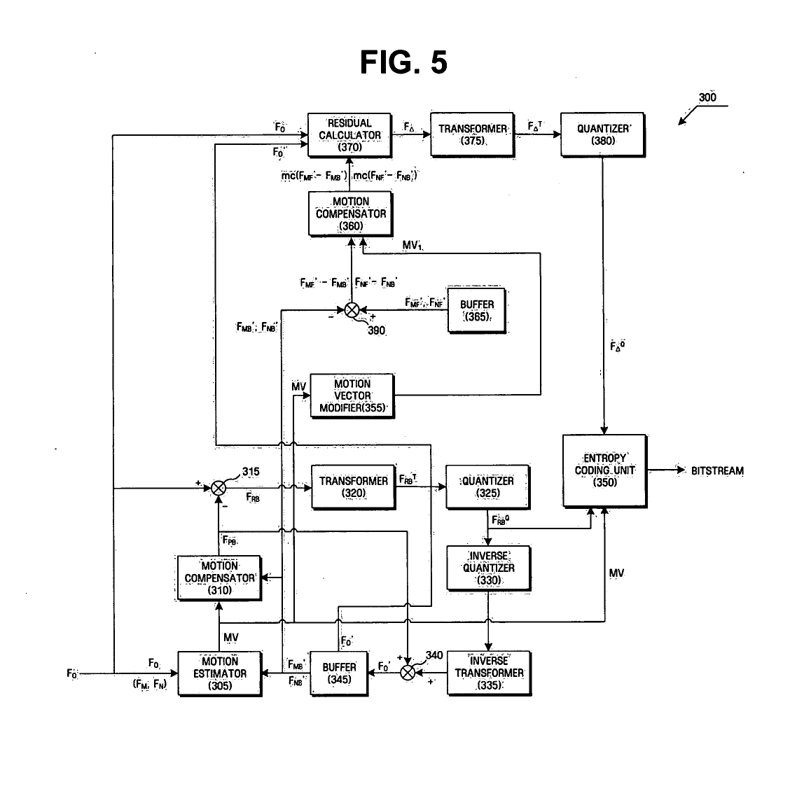

FIG. 5 is a block diagram of a video encoder 300 according to a third exemplary embodiment of the present invention. Referring to FIG. 5, while in the first and second exemplary embodiments, the residual between the base layer reference image and the FGS layer reference image is calculated after performing motion compensation, the illustrated video encoder 300 performs motion compensation after calculating the residual between reference frames in the two layers. To avoid repetitive explanation, the following description will focus on distinguished features between the first and second exemplary embodiments.

A subtractor 390 subtracts reconstructed base layer reference frames F_{MB}′ and F_{NB}′, which are received from a buffer 345, from FGS layer reference frames F_{MF}′ and F_{NF}′, which are received from a buffer 365, and provides the subtraction results F_{MF}′−F_{MB}′ and F_{NF}′−F_{NB}′ to a motion compensator 360. When a unidirectional reference frame is used, only one residual exists.

The motion compensator 360 uses a modified motion vector MV₁ received from a motion vector modifier 355 to perform motion compensation on the residuals F_{MF}′−F_{MB}′ and F_{NF}′−F_{NB}′ between the FGS layer reference frame and the base layer reference frame received from the subtractor 390. When the motion vector MV₁ with ½ pixel accuracy is used during the motion compensation, a bi-linear filter requiring a small amount of computations may be used for interpolation instead of a six-tap filter used in the H.264 standard. As described above, the interpolation little affects the compression efficiency.

A residual calculator 370 calculates an average between the motion-compensated residuals mc(F_{MF}′−F_{MB}′) and mc(F_{NF}′−F_{NB}′) and subtracts the reconstructed image F_{O}′ and the average from the current frame F_{O}. When unidirectional reference frame is used, the averaging process is not required.

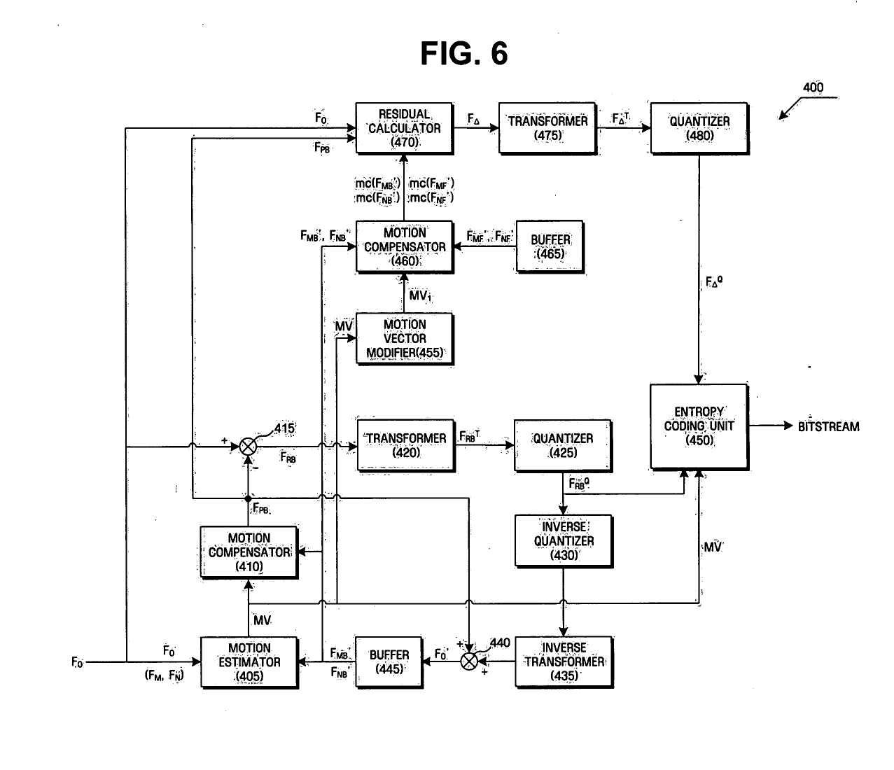

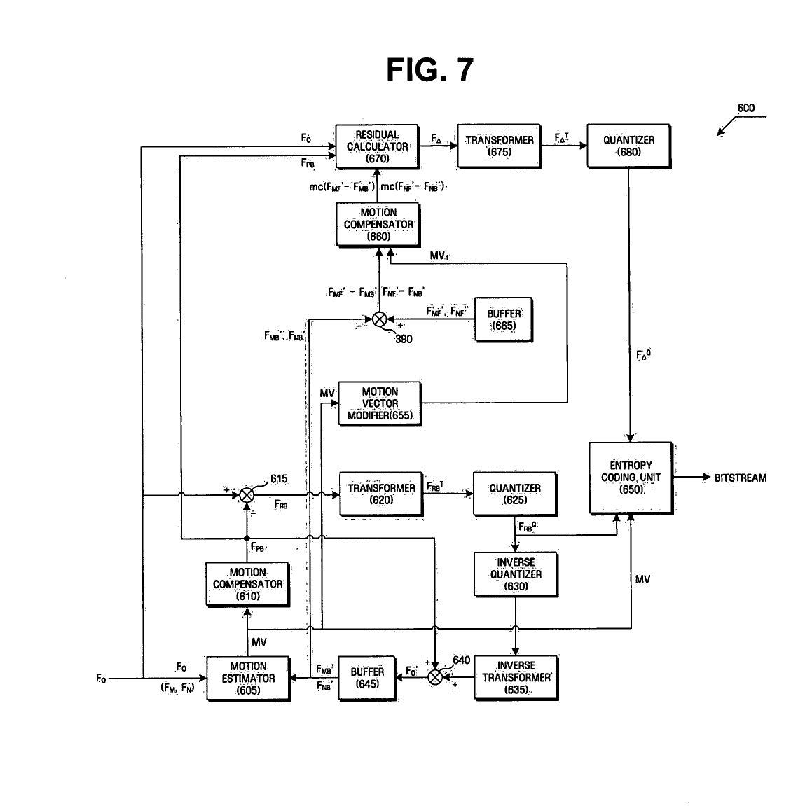

FIGS. 6 and 7 are block diagrams of examples of video encoders 400 and 600 according to a fourth exemplary embodiment of the present invention. Referring first to FIG. 6, unlike in the first exemplary embodiment shown in FIG. 4, a residual calculator 470 in the video encoder 400 of the exemplary embodiment subtracts a predicted base layer frame FP_{B}, instead of the reconstructed base layer frame F_{O}′, from the current frame F_{O}.

The video encoders 400 and 600 according to the fourth exemplary embodiment shown in FIGS. 6 and 7 correspond to FIGS. 4 and 5 illustrating video encoders 100 and 300 according to the first and third exemplary embodiments. Referring first to FIG. 6, the residual calculator 470 subtracts the predicted base layer image F_{PB} received from a motion compensator 410, instead of the reconstructed base layer image F_{O}′, from the current frame. Thus, the residual calculator 470 subtracts the predicted image F_{PB} and an average of the residuals Δ_{M} and Δ_{N} from the current frame F_{O} to obtain a subtraction result F_{Δ}.

Similarly, referring to FIG. 7, the residual calculator 670 subtracts the predicted image F_{PB} and an average of the motion-compensated residuals mc(F_{MF}′−F_{MB}′) and mc(F_{NF}′−F_{NB}′)) from the current frame F_{O} to obtain a subtraction result F_{Δ}.

An example of a video encoder according to a fourth exemplary embodiment corresponding to the second exemplary embodiment (not shown) may have the same configuration and perform the same operation as shown in FIG. 6 except for the operation of the residual calculator 470. In the video encoder of the fourth exemplary embodiment corresponding to the second exemplary embodiment, the residual calculator 470 generates a predicted FGS layer frame F_{PF} and a predicted base layer frame F_{BF} using a motion-compensated FGS layer reference frame mc(F_{MF}′), mc(F_{NF}′) and a motion-compensated base layer reference frame mc(F_{MB}′), mc(F_{NB}′), respectively. The residual calculator 470 also calculates a residual F_{PF}−F_{PB} between the predicted frames F_{PF} and F_{PB} and subtracts the reconstructed image F_{O}′ and the residual F_{PF}−F_{PB} from the current frame F_{O} to obtain a subtraction result F_{Δ}.

If leaky prediction is applied, the residual calculator 470 multiplies a weighting factor α by the residual F_{PF}−F_{PB} and subtracts the reconstructed image F_{O}′ and the product (α×(F_{PF}−F_{PB})) from the current frame F_{O} to obtain a subtraction result F_{Δ}.

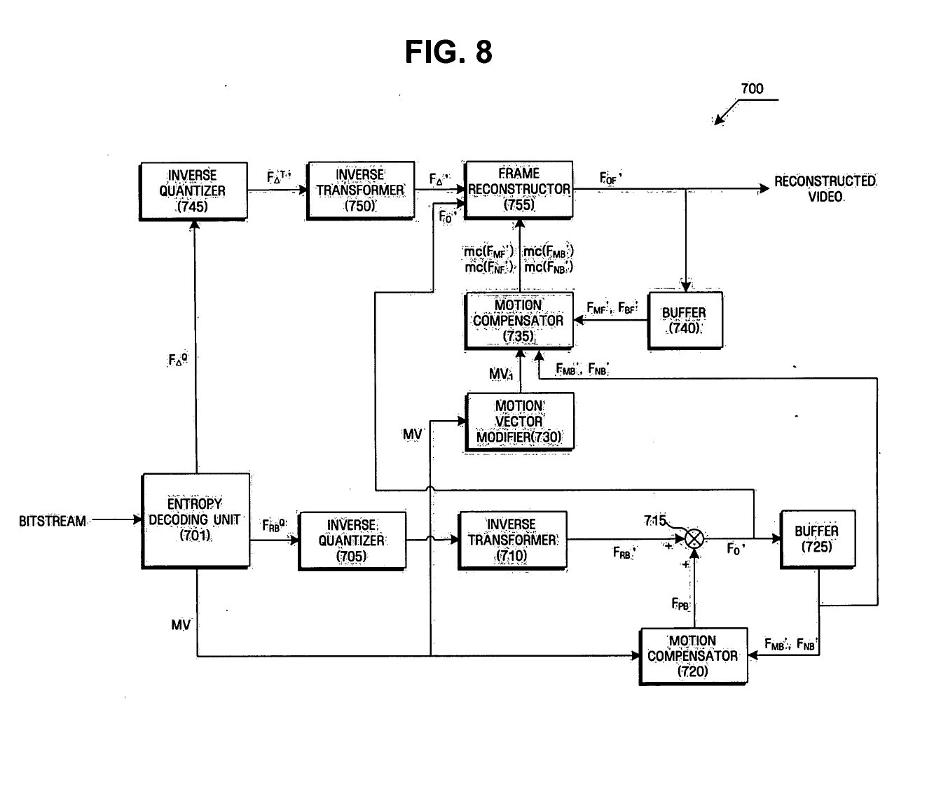

FIG. 8 is a block diagram of a video decoder 700 according to a first exemplary embodiment of the present invention. Referring to FIG. 8, an entropy decoding unit 701 losslessly decodes an input bitstream to extract base layer texture data F_{PB}^{Q}, FGS layer texture data F_{Δ}^{Q}, and motion vectors MVs. The lossless decoding is an inverse process of lossless encoding.

The base layer texture data F_{PB}^{Q} and the FGS layer texture data F_{Δ}^{Q} are provided to inverse quantizers 705 and 745, respectively, and the motion vectors MVs are provided to a motion compensator 720 and a motion vector modifier 730.

The inverse quantizer 705 applies inverse quantization to the base layer texture data F_{PB}^{Q} received from the entropy decoding unit 701. The inverse quantization is performed in a reverse order to that of the quantization performed by the transformer to restore values matched to indices generated during quantization according to a predetermined quantization step used in the quantization.

An inverse transformer 710 performs inverse transform on the inverse quantized result. The inverse transformation is performed in a reverse order to that of the transformation performed by the transformer. Specifically, inverse DCT transformation, or inverse wavelet transformation may be used.

The reconstructed residual F_{RB}′ is provided to an adder 715.

The motion compensator 720 performs motion compensation on previously reconstructed base layer reference frames F_{MB}′ and F_{NB}′ stored in a buffer 725 using the extracted motion vectors MVs to generate a predicted image F_{PB}, which is then sent to the adder 715.

When bidirectional prediction is used, the predicted image F_{PB} is calculated by averaging the motion-compensated reference frames. When unidirectional prediction is used, the predicted image F_{PB} is obtained as a motion-compensated reference frame.

The adder 715 adds together the input F_{RB} and F_{PB} to output a reconstructed base layer image F_{O}′ that is then stored in the buffer 725.

An inverse quantizer 745 applies inverse quantization to the FGS layer texture data F_{Δ}^{Q}, and an inverse transformer 750 performs inverse transform on the inversely quantized result F_{Δ}^{T}, to obtain a reconstructed frame F_{Δ} (F_{Δ}′) that is then provided to a frame reconstructor 755.

The motion vector modifier 730 lowers the accuracy of the extracted motion vector MV. For example, a motion vector MV with ¼ pixel accuracy may have a value of 0, 0.25, 0.5, or 0.75. The motion vector modifier 730 changes the motion vector MV with ¼ pixel accuracy into a motion vector MVI with pixel accuracy lower than the ¼ pixel accuracy, such as ½ pixel or 1 pixel.

A motion compensator 735 uses the modified motion vector MV₁ to perform motion compensation on reconstructed base layer reference frames F_{MB}′ and F_{NB}′ received from the buffer 725 and reconstructed FGS layer reference frames F_{MF}′ and F_{NF}′ received from the buffer 740 and provides a motion-compensated base layer frame mc(F_{MB}′), mc(F_{NB}′), and a motion-compensated FGS layer frame mc(F_{MF}′), mc(F_{NF}′) to the frame reconstructor 755.

When the motion vector MV₁ with ½ pixel accuracy, for example, is used during motion compensation, a bi-linear filter requiring a small amount of computations may be used for interpolation instead of a six-tap filter used in the H.264 standard. The interpolation process little affects the compression efficiency.

The frame reconstructor 755 calculates a residual Δ_{M} between the motion-compensated FGS layer and base layer reference frames mc(F_{MF}′) and mc (F_{MB}′), that is, Δ_{M}=mc(F_{MF}′)−mc(F_{MB}′), and a residual Δ_{N} between the motion-compensated FGS layer and base layer reference frames mc(F_{NF}′) and mc(F_{NB}′), that is, Δ_{N}=mc(F_{NF}′)−mc(F_{NB}′). Of course, when a unidirectional reference frame is used, only one residual may be calculated.

The frame reconstructor 755 also calculates an average of the residuals Δ_{M} and Δ_{N} and adds the average, F_{Δ}′, and the reconstructed base layer image F_{O}′ together to generate a reconstructed FGS layer image F_{OF}′. When a unidirectional reference frame is used, the averaging process is not required.

The buffer 740 then stores the reconstructed image F_{OF}′. Of course, the previously reconstructed images F_{MF}′ and F_{BF}′ can be stored in the buffer 740.

Alternatively, a video decoder according to a second exemplary embodiment of the present invention may have the same configuration and perform the same operation as shown in FIG. 8 except for the operation of a frame reconstructor. That is, the frame reconstructor according to the second exemplary embodiment generates a predicted frame for each layer before calculating a residual between frames in the two layers. That is to say, the frame reconstructor generates a predicted FGS layer frame and a predicted base layer frame using motion-compensated FGS layer reference frames and motion-compensated base layer frames. The predicted frames can be generated by simply averaging the two motion-compensated reference frames. Of course, when unidirectional prediction is used, the predicted frame is a motion-compensated frame itself.

The frame reconstructor then calculates a residual between the predicted frames, and adds together the texture data, the reconstructed base layer frame, and the residual.

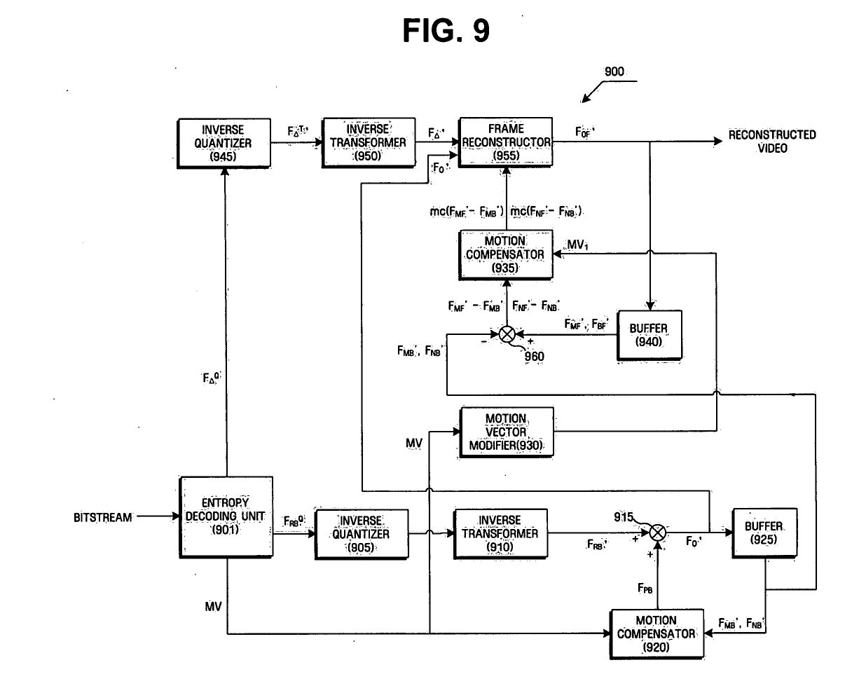

FIG. 9 is a block diagram of a video decoder 900 according to a third exemplary embodiment of the present invention. Referring to FIG. 9, unlike in the first and second exemplary embodiments in which motion compensation is performed before calculating a residual between an FGS layer reference image and a base layer reference image, the video decoder 900 performs motion compensation after calculating a residual between the reference frames in the two layers. To avoid repetitive explanation, the following description will focus on distinguished features of the first exemplary embodiment shown in FIG. 4.

A subtractor 960 subtracts reconstructed base layer reference frames F_{MB}′ and F_{NB}′ received from a buffer 925 from FGS layer reference frames F_{MF}′ and F_{NF}′ and provides the subtraction results F_{MF}′−F_{MB}′ and F_{NF}′−F_{NB}′ to a motion compensator 935. When a unidirectional reference frame is used, only one residual exists.

The motion compensator 935 uses a modified motion vector MV₁ received from a motion vector modifier 930 to perform motion compensation on the residuals F_{MF}′−F_{MB}′ and F_{NF}′−F_{NB}′ between the reference frames in the FGS layer and the base layer received from the subtractor 960. When the motion vector MV₁ with ½ pixel accuracy is used during the motion compensation, a bi-linear filter requiring a small amount of computations may be used for interpolation instead of a six-tap filter used in the H.264 standard. As described above, the interpolation little affects the compression efficiency.

The frame reconstructor 955 calculates an average between motion-compensated residuals, that is, an average between mc(F_{MF}′−F_{MB}′) and mc(F_{NF}′−F_{NB}′), and adds together the calculated average, F_{Δ}′ received from an inverse transformer 950, and a reconstructed base layer image F_{O}′. When unidirectional reference frame is used, the averaging process is not required.

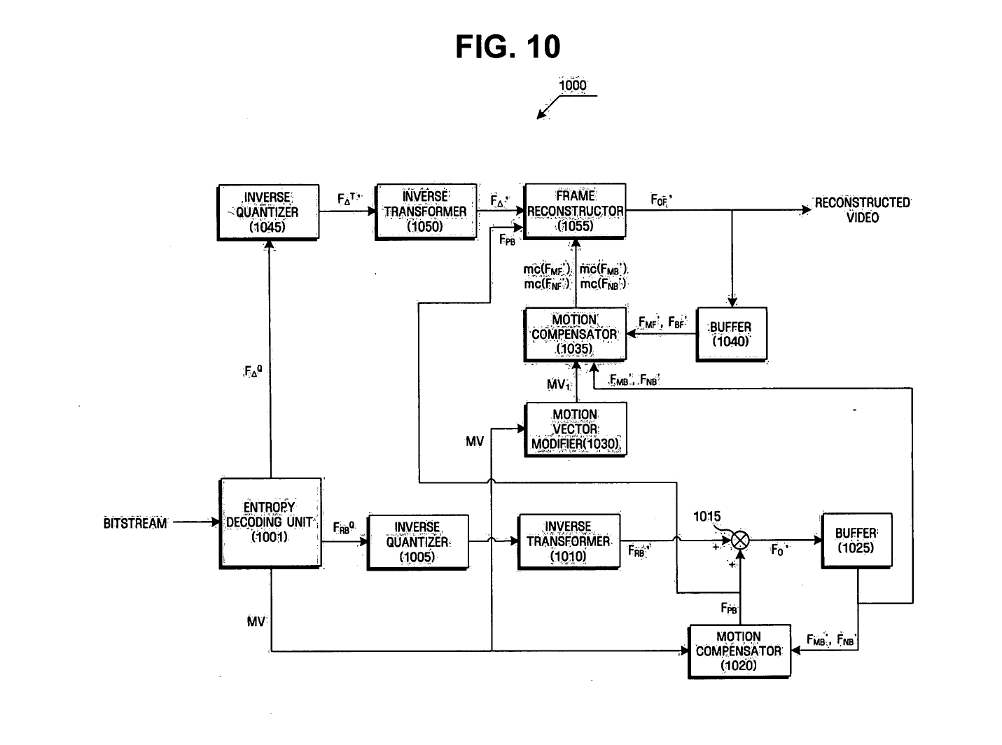

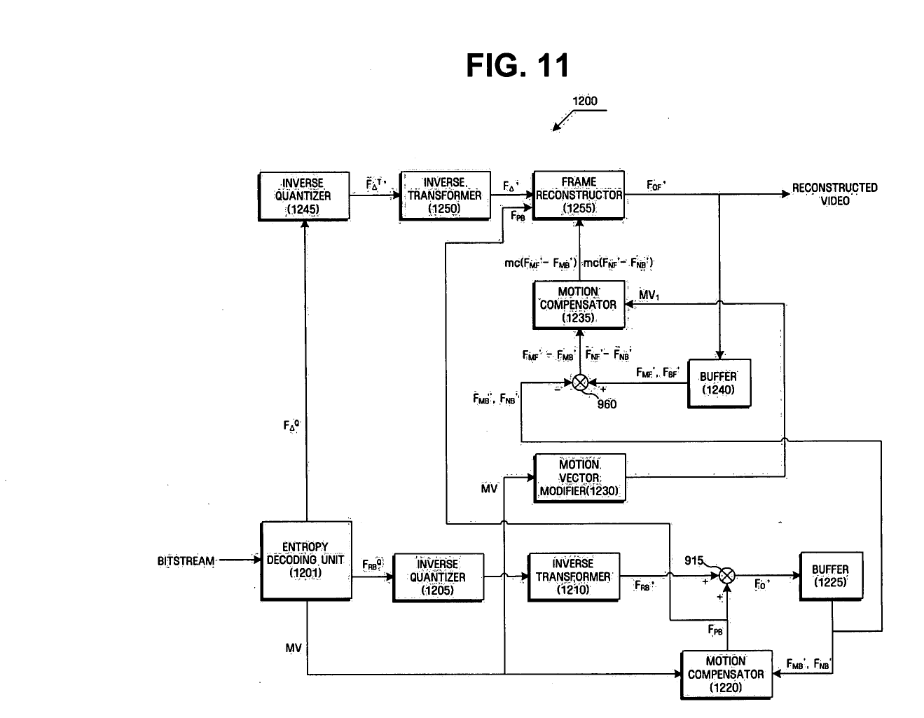

FIGS. 10 and 11 are block diagrams of examples of video decoders 1000 and 1200 according to a fourth exemplary embodiment of the present invention.

Referring to FIGS. 10 and 11, corresponding to FIGS. 8 and 9 illustrating the video decoders 700 and 900 according to the first and third exemplary embodiments, frame reconstructors 1055 and 1255 add a predicted base layer frame FPB, instead of the reconstructed base layer frame F_{O}′.

The video decoders 1000 and 1200 according to the fourth exemplary embodiment shown in FIGS. 10 and 11 correspond to those according to the first and third exemplary embodiments shown in FIGS. 8 and 9, respectively.

Referring first to FIG. 10, corresponding to FIG. 8, the motion compensator 1020 provides the base layer reference image F_{PB} to the frame reconstructor 1055, instead of the reconstructed image F_{O}′. Thus, the frame reconstructor 470 adds together F_{Δ}′ received from the inverse transformer 1050, the predicted base layer image F_{PB}, and an average of interlayer residuals Δ_{M} and Δ_{N} to obtain the reconstructed base layer image F_{OF}′.

Similarly, referring to FIG. 11, the frame reconstructor 1255 adds together F_{Δ}′ received from an inverse transformer 1250, the predicted base layer image F_{PB} received from a motion compensator 1220, and an average of motion-compensated residuals mc(F_{MF}′−F_{MB}′) and mc(F_{NF}′−F_{NB}′)) to obtain a reconstructed FGS layer image F_{OF}′.

Meanwhile, the video decoder according to the fourth exemplary embodiment, corresponding to the video decoder according to the second exemplary embodiment (not shown), may have the same configuration and perform the same operation as shown in FIG. 8 except for the operation of the frame reconstructor 1255. In the video decoder of the fourth exemplary embodiment corresponding to the second exemplary embodiment, the frame reconstructor 1255 generates a predicted FGS layer frame F_{PF} and a predicted base layer frame F_{BF} using motion-compensated FGS layer reference frames mc(F_{MF}′) and mc(F_{NF}′) and motion-compensated base layer reference frames mc(F_{MB}′) and mc(F_{NB}′). The frame reconstructor 1255 also calculates a residual F_{PF}−F_{PB} between a predicted FGS layer frame F_{PF} and a predicted base layer frame F_{PB} and adds together F_{Δ}′ received from the inverse transformer 1250, the predicted image F_{PB} received from the motion compensator 1220, and the residual F_{PF}−F_{PB} to obtain the reconstructed image F_{OF}′.

When leaky prediction (fifth exemplary embodiment) is applied, the frame reconstructor 1255 multiplies a weighting factor α by the interlayer residual F_{PF}−F_{PB} and adds together F_{Δ}′, F_{O}′ and the product α×(F_{PF}−F_{PB}) to obtain F_{OF}′.

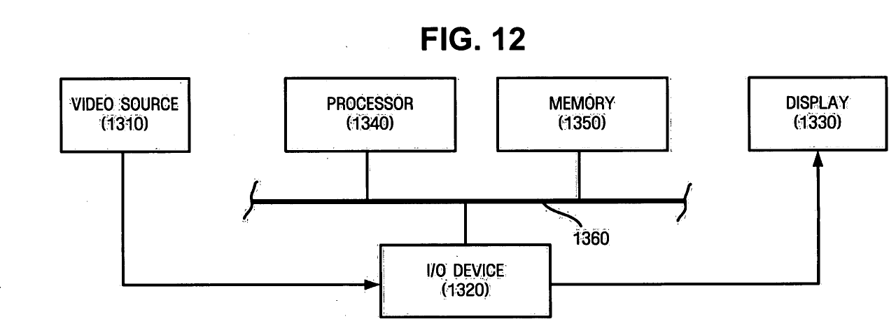

FIG. 12 is a block diagram of a system for performing an encoding or decoding process using a video encoder 100, 300, 400, 600 or a video decoder 700, 900, 1000, 1200, according to an exemplary embodiment of the present invention. The system may be a TV, a set-top box (STB), a desktop, laptop, or palmtop computer, PDA, a video or image storage device (e.g., a VCR, or a DVR). The system may be a combination of the devices listed above or another device incorporating them. In addition, the system may be a combination of the above-mentioned apparatuses or one of the apparatuses which includes a part of another apparatus among them. The system includes at least one video source 1310, at least one input/output unit 1320, a processor 1340, a memory 1350, and a display unit 1330.

The video source 1310 may be a TV receiver, a VCR, or other video storing apparatus. The video source 1310 may indicate at least one network connection for receiving a video or an image from a server using Internet, a wide area network (WAN), a local area network (LAN), a terrestrial broadcast system, a cable network, a satellite communication network, a wireless network, a telephone network, or the like. In addition, the video source 1310 may be a combination of the networks or one network including a part of another network among the networks.

The input/output device 1320, the processor 1340, and the memory 1350 communicate with one another through a communication medium 1360. The communication medium 1360 may be a communication bus, a communication network, or at least one internal connection circuit. Input video data received from the video source 1310 can be processed by the processor 1340 using to at least one software program stored in the memory 1350 and can be executed by the processor 1340 to generate an output video provided to the display unit 1330.

In particular, the software program stored in the memory 1350 includes a scalable wavelet-based codec performing a method of the present invention. The codec may be stored in the memory 1350, may be read from a storage medium such as a compact disc-read only memory (CD-ROM) or a floppy disc, or may be downloaded from a predetermined server through a variety of networks.

As described above, the present invention provides video coding that can significantly reduce the amount of computations required to implement a PFGS algorithm. Since a decoding process is modified according to a video coding process of the present invention, the present invention can be applied to the H.264 SE standardized document.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A video encoding method supporting fine granular scalability (FGS), the method comprising:
obtaining a predicted image for a current frame using a first motion vector estimated at predetermined accuracy;
quantizing a residual between the current frame and the predicted image, inversely quantizing the quantized residual and generating a reconstructed image for the current frame;
performing motion compensation on an FGS layer reference frame and a base layer reference frame using a second motion vector;
calculating a residual between the motion-compensated FGS layer reference frame and the motion-compensated base layer reference frame;
subtracting the reconstructed image for the current frame and the calculated residual from the current frame; and
encoding a result of subtracting.

2. The method of claim 1, wherein the performing of the motion compensation comprises generating the second motion vector by changing an accuracy of the first motion vector, and an accuracy of the second motion vector used in the performing of the motion compensation is lower than the accuracy of the first motion vector used in the obtaining of the predicted image for the current frame.

3. The method of claim 1, wherein the calculated residual is an average of a first residual between a forward FGS layer reference frame and a forward base layer reference frame and a second residual between a backward FGS layer reference frame and a backward base layer reference frame.

4. The method of claim 2, wherein if interpolation is performed for the motion compensation, a different type of interpolation filter than that used in the obtaining of the predicted image for the current frame is used for the interpolation.

5. The method of claim 1, wherein the encoding of the result of the subtracting comprises:
transforming the result of the subtracting to generate a transform coefficient;
quantizing the transform coefficient to generate a quantization coefficient; and
losslessly encoding the quantization coefficient.

6. The method of claim 1, wherein the obtaining of the predicted image for the current frame comprises:
estimating the first motion vector using the current frame and at least one reconstructed base layer frame as reference frames;
performing motion compensation on the reference frames using the first motion vector; and
obtaining the predicted image by averaging the motion-compensated reference frames.

7. The method of claim 1, wherein the obtaining of the predicted image for the image comprises:
estimating the first motion vector using the current frame and an original frame adjacent to the current frame as a reference frame;
performing motion compensation on the reference frame using the first motion vector; and
obtaining the predicted image by averaging the motion-compensated reference frames.

8. The method of claim 1, wherein the FGS layer reference frame is an original frame adjacent to an FGS layer reference frame and the base layer reference frame is a neighboring frame reconstructed from the base layer.

9. The method of claim 1, wherein the FGS layer reference frame is a neighboring frame reconstructed from the FGS layer and the base layer reference frame is a neighboring frame reconstructed from the base layer.

10. The method of claim 5, wherein a quantization step size used in the quantizing of the transform coefficient is smaller than that used in the quantizing of the residual.

11. A video encoding method supporting fine granular scalability (FGS), the method comprising:
obtaining a predicted image for a current frame using a first motion vector estimated at predetermined accuracy;
quantizing a residual between the current frame and the predicted image, inversely quantizing the quantized residual, and generating a reconstructed image for the current frame;
performing motion compensation on an FGS layer reference frame and a base layer reference frame using a second motion vector and generating a predicted frame for the FGS layer and a predicted frame for the base layer, respectively;
calculating a residual between the predicted frame for the FGS layer and the predicted frame for the base layer;
subtracting the reconstructed image and the residual from the current frame; and
encoding a result of the subtracting.

12. The method of claim 11, wherein the performing of the motion compensation comprises generating the second motion vector by changing an accuracy of the first motion vector, and an accuracy of the second motion vector used in the performing of the motion compensation is lower than the accuracy of the first motion vector used in the obtaining of the predicted image for the current frame.

13. The method of claim 11, wherein the predicted FGS layer frame is an average of motion-compensated FGS layer reference frames and the predicted base layer frame is an average of motion-compensated base layer reference frames.

14. The method of claim 12, wherein if interpolation is performed for the motion compensation, a different type of interpolation filter than that used in the obtaining of the predicted image for the current frame is used for the interpolation.

15. The method of claim 11, wherein the encoding of the result of the subtracting comprises:
transforming the result of the subtracting to generate a transform coefficient;
quantizing the transform coefficient to generate a quantization coefficient; and
losslessly encoding the quantization coefficient.

16. The method of claim 15, wherein a quantization step size used in the quantizing of the transform coefficient is smaller than that used in the quantizing of the residual.

17. A video encoding method supporting fine granular scalability (FGS), the method comprising:
obtaining a predicted image for a current frame using a first motion vector estimated at predetermined accuracy;
quantizing a residual between the current frame and the predicted image, inversely quantizing the quantized residual, and generating a reconstructed image for the current frame;
calculating a residual between a fine granular scalability (FGS) layer reference frame and a base layer reference frame;
performing motion compensation on the residual using a second motion vector;
subtracting the reconstructed image and a result of the motion compensation from the current frame; and
encoding a result of subtracting.

18. The method of claim 17, wherein the performing of the motion compensation comprises generating the second motion vector by changing an accuracy of the first motion vector, and an accuracy of the second motion vector used in the performing of the motion compensation on the residual is lower than the accuracy of the first motion vector used in the obtaining of the predicted image for the current frame.

19. The method of claim 17, wherein the result of the motion compensation subjected to the subtracting is an average of motion-compensated residuals.

20. The method of claim 18, wherein if interpolation is performed for the motion compensation, a different type of interpolation filter than that used in the obtaining of the predicted image for the current frame is used for the interpolation.

21. The method of claim 17, wherein the encoding of the result of the subtracting comprises:
transforming the result of the subtracting to generate a transform coefficient;
quantizing the transform coefficient to generate a quantization coefficient; and
losslessly encoding the quantization coefficient.

22. The method of claim 21, wherein a quantization step size used in the quantizing of the transform coefficient is smaller than that used in the quantizing of the residual.

23. A video encoding method supporting fine granular scalability (FGS), the method comprising:
obtaining a predicted image for a current frame using a first motion vector estimated at predetermined accuracy;
performing motion compensation on an FGS layer reference frame and a base layer reference frame using a second motion vector with lower accuracy than that of the first motion vector;
calculating a residual between the motion-compensated FGS layer and base layer reference frame;
subtracting the predicted image and the residual from the current frame; and
encoding the result of the subtracting.

24. A video encoding method supporting fine granular scalability (FGS), the method comprising:
obtaining a predicted image for a current frame using a first motion vector estimated at predetermined accuracy;
performing motion compensation on an FGS layer reference frame and a base layer reference frame using a second motion vector with lower accuracy than that of the first motion vector and generating a predicted frame for the FGS layer and a predicted frame for the base layer, respectively;
calculating a residual between the predicted frame for the FGS layer and the predicted frame for the base layer;
subtracting the predicted image and the calculated residual from the current frame; and
encoding the result of the subtracting.

25. The method of claim 24, further comprising multiplying the residual between the predicted frame for the FGS layer and the predicted frame for the base layer by a weighting factor a, wherein the calculated residual in the subtracting of the predicted image is the product of the weighting factor a and the residual between the predicted frame for the FGS layer and the predicted frame for the base layer.

26. A video encoding method supporting fine granular scalability (FGS), the method comprising:
obtaining a predicted image for a current frame using a first motion vector estimated at predetermined accuracy;
calculating a residual between an FGS layer reference frame and a base layer reference frame;
performing motion compensation on the residual using a second motion vector with lower accuracy than that of the first motion vector;
subtracting the reconstructed image and a result of the motion compensation from the current frame; and
encoding the restilt of the subtracting.

27. A video decoding method supporting fine granular scalability (FGS), the method comprising:
extracting base layer texture data and FGS layer texture data and a first motion vector from an input bitstream;
reconstructing a base layer frame from the base layer texture data;
performing motion compensation on an FGS layer reference frame and a base layer reference frame using a second motion vector;
calculating a residual between the motion-compensated FGS layer reference frame and the motion-compensated base layer reference frame; and
adding together the base layer frame, the FGS layer texture data, and the residual.

28. The method of claim 27, wherein the second motion vector used in the performing of the motion compensation have low accuracy than the first motion vector.

29. The method of claim 27, wherein the calculated residual is an average of a first residual between a forward FGS layer reference frame and a forward base layer reference frame and a second residual between a backward FGS layer reference frame and a backward base layer reference frame.

30. The method of claim 28, wherein if interpolation is performed for the motion compensation, a different type of interpolation filter than that used in the reconstructing of the base layer frame is used for the interpolation.

31. The method of claim 27, wherein the FGS layer texture data in the adding of the base layer frame is obtained by performing inverse quantization and inverse transform on the extracted FGS layer texture data.

32. The method of claim 31, wherein the reconstructing of the base layer frame comprises:
inversely quantizing the base layer texture data;
inversely transforming a result of the inversely quantizing;
generating a predicted image from a previously reconstructed base layer reference frame using the first motion vector; and
adding together the predicted image and a result of the inversely transforming.

33. The method of claim 32, wherein a quantization step size used in the inverse quantization applied to the FGS layer texture data is smaller than that used in the inverse quantization performed in the reconstructing of the base layer frame.

34. A video decoding method supporting fine granular scalability (FGS), the method comprising:
extracting base layer texture data and FGS layer texture data and a first motion vector from an input bitstream;
reconstructing a base layer frame from the base layer texture data;
performing motion compensation on an FGS layer reference frame and a base layer reference frame using a second motion vector and generating a predicted FGS layer frame and a predicted base layer frame;
calculating a residual between the predicted FGS layer reference frame and the predicted base layer reference frame; and
adding together the texture data, the reconstructed base layer frame, and the residual.

35. The method of claim 34, wherein the second motion vector used in the performing of the motion compensation have lower accuracy than the first motion vector.

36. The method of claim 35, wherein if interpolation is performed for motion compensation, a different type of interpolation filter than that used in the reconstructing of the base layer frame is used for the interpolation.

37. The method of claim 34, wherein the FGS layer texture data in the adding of the base layer frame, the texture data in the FGS layer, and the residual is obtained by performing inverse quantization and inverse transform on the extracted FGS layer texture data.

38. A video decoding method supporting fine granular scalability (FGS), the method comprising:
extracting base layer texture data and FGS layer texture data and a first motion vector from an input bitstream;
reconstructing a base layer frame from the base layer texture data;
calculating a residual between an FGS layer reference frame and a base layer reference frame;
performing motion compensation on the residual using a second motion vector; and
adding together the FGS layer texture data, the reconstructed base layer frame, and a result of the motion compensation.

39. The method of claim 38, wherein the result of the motion compensation subjected to the adding is an average of motion-compensated residuals.

40. The method of claim 38, wherein the second motion vector used in the performing of motion compensation has lower accuracy than the first motion vector.

41. The method of claim 40, wherein if interpolation is performed for the motion compensation, a different type of interpolation filter than that used in the reconstructing of the base layer frame is used for the interpolation.

42. The method of claim 38, wherein the FGS layer texture data in the adding is obtained by performing inverse quantization and inverse transform on the extracted FGS layer texture data.

43. A video decoding method supporting fine granular scalability (FGS), the method comprising:
extracting base layer texture data, FGS layer texture data and a first motion vector from an input bitstream;
reconstructing a predicted image for a base layer frame from the base layer texture data using the first motion vectors;
performing motion compensation on an FGS layer reference frame and a base layer reference frame using a second motion vector with lower accuracy than that of the first motion vector;
calculating a residual between a motion-compensated FGS layer reference frame and a motion-compensated base layer reference frame; and
adding together the FGS layer texture data, the predicted image, and the calculated residual.

44. A video decoding method supporting fine granular scalability (FGS), the method comprising:
extracting base layer texture data, FGS layer texture data and a first motion vectors from an input bitstream;
reconstructing a predicted image for a base layer frame from the base layer texture data using the first motion vector;
performing motion compensation on an FGS layer reference frame and a base layer reference frame using a second motion vector with lower accuracy than that of the first motion vector and generating a predicted FGS layer frame and a predicted base layer frame;
calculating a residual between the predicted FGS layer frame and the predicted base layer frame; and
adding together the FGS layer texture data, the predicted images, and the calculated residual.

45. The method of claim 25, further comprising multiplying the residual between the predicted FGS layer frame and the predicted base layer frame by a weighting factor a, wherein the calculated residual in the adding is a product of the weighting factor a and the residual between the predicted FGS layer frame and the predicted base layer frame.

46. A video decoding method supporting fine granular scalability (FGS), the method comprising:
extracting base layer texture data, FGS layer texture data and a first motion vector from an input bitstream;
reconstructing a predicted image for a base layer frame from the base layer texture data using the first motion vector;
calculating a residual between an FGS layer reference frame and a base layer reference frame;
performing motion compensation on the residual using a second motion vector with lower accuracy than that of the first motion vector; and
adding together the FGS layer texture data, the predicted image, and the residual.

47. A fine granular scalability (FGS)-based video encoder comprising:
means for obtaining a predicted image for a current frame using a first motion vector estimated at predetermined accuracy;
means for quantizing a residual between the current frame and the predicted image, inversely quantizing the quantized residual, and generating a reconstructed image for the current frame;
means for performing motion compensation on an FGS layer reference frame and a base layer reference frame using a second motion vector;
means for calculating a residual between the motion-compensated FGS layer and base layer reference frame;
means for subtracting the reconstructed image and the residual from the current frame; and
means for encoding a result of the subtracting.

48. The encoder of claim 47, wherein an accuracy of the second motion vector used in the performing of the motion compensation is lower than an accuracy of the first motion vector used in the obtaining of the predicted image for the current frame.

49. A fine granularity scalability (FGS)-based video decoder comprising:
means for extracting base layer texture data, FGS layer texture data and a first motion vector from an input bitstream;
means for reconstructing a base layer frame from the base layer texture data;
means for performing motion compensation on an FGS layer reference frame and a base layer reference frame using a second motion vector and generating a predicted FGS layer frame and a predicted base layer frame;
means for calculating a residual between the predicted FGS layer frame and the predicted base layer frame; and
means for adding together the texture data, the reconstructed base layer frame, and the residual.

50. The decoder of claim 49, wherein an accuracy of the second motion vector used in the performing of the motion compensation is lower than an accuracy of the first motion vector extracted from the input bitstream.
